(19) United States
(12) Patent Application Publication
(10) Pub. No.: US 2009/0071731 A1
(43) Pub. Date: Mar. 19, 2009

(54) Analytical Scale

(75) Inventor: Stephan Gerster, Bad Breisig (DE)

Correspondence Address: MOORE & VAN ALLEN PLLC, P.O. BOX 13706, Research Triangle Park, NC, 27709, US

(73) Assignee: Soehnie Professional GmbH & Co. KG, Murnhardt (DE)

(21) Appl. No.: 12/094,529

(22) PCT Filed: Nov. 21, 2006
(86) PCT No.: PCT/DE2006/002057

§ 371 Date: Sep. 17, 2008

(30) Foreign Application Priority Data
Nov. 21, 2005 (DE) 102005055772.4

(51) Int. Cl. G01G 23/30; G01G 19/00

(52) U.S. Cl. 177/177; 177/245

(57) ABSTRACT

The invention relates to a bathroom scale for a person to be weighed to step on. Said scale has at least one handle to which the person to be weighed can hold on while stepping onto the scale and an electric and/or optical measuring sensor arranged on the handle.

The invention relates to a bathroom scale or the like (for weighing individual humans), onto which the person being weighed (user) applies his weight by stepping on the scale, which scale comprises at least one hand grip with which the user can steady himself hold while on the scale.

WO 0022388 discloses a remotely monitored platform comprised of a scale and a handrail for supporting the user.

For some time, scales have been known which additionally measure the user's body fat content by measuring his electrical resistance (bioimpedance method). The step-on surface of such scales has two electrodes between which a voltage is applied. A disadvantage of such scales is the poor accuracy of the result.

The underlying problem of the present invention was to devise a bathroom scale or the like which is capable of providing improved measurements of body fat content, and which offers additional functions.

This problem is solved by a bathroom scale or the like which is characterized in that the hand grip has at least one electrical and/or optical measurement sensor.

The invention has the advantage of making available a variety of methods and means of measuring physiological parameters.

The disposition of the measurement sensors on the hand grip enables more accurate measurement of the body resistance, in particular because the resistance between the hands is measured, or between a hand and a foot, and the measurements can be mutually compared and adjusted.

The disposition of the measurement sensors on the hand grip also allows measurement of the pulse frequency of the user by measurement of the voltage between two contact surfaces. This was not possible using the scales according to state of the art, because the voltage signal produced by the heart is not measurable between the feet.

The invention further enables optical determination of the user's pulse and thus his pulse frequency. For this purpose, according to the invention the back-dispersion of the tissue, and the reflectivity of the tissue, both of which vary with time in accordance with the pulse, are determined.

According to a particular embodiment, the user's blood pressure is calculated, based on the timewise course of the voltage signal correlated with the pulse and the timewise course of the optical signal correlated with the pulse.

According to another embodiment of the inventive scale, the measurement sensor has at least one electrical contact surface. Preferably, the measurement sensor also has a second electrical contact surface. The first and second electrical contact surfaces may be employed, e.g., to determine the fat content of the user's body by measuring the electrical body resistance. For this purpose, a test voltage, preferably an alternating-current voltage, may be applied between the contact surfaces, and the current flowing through the user's body can be measured. An additional contact surface may be provided in the step-on surface of the scale, independently of whether a “second contact surface” as described is provided. This allows measurements between hand and foot to be taken. Particularly good accuracy of body resistance can be achieved via a plurality of measurements—hand to hand and/or foot to hand and/or foot to foot.

An embodiment of the inventive scale in which the measurement sensor has at least one electrical contact surface is particularly well suited to detecting a user's pulse. The voltage generated by the user's heart (particularly, the sino-atrial node) can be determined between the hands (thus between the first and second contact surfaces), or between a hand and a foot (thus between the first contact on the hand grip and the “additional” contact surface in the step-on plate). Preferably means are provided which measure a voltage applied between the first and second electrical contact surface and/or between the first and “additional,” electrical contact surface—preferably as a function of time.

According to a particular embodiment, the measurement sensor has a light detector. This may be in the form of, e.g., a semiconductor detector, e.g. a photodiode, or a photomultiplier. According to a particular embodiment, the light detector particularly detects red and/or infrared light.

According to another embodiment of the inventive scale, the measurement sensor has a light source. The light source may be in the form of, e.g., a light emitting diode (LED) and/or a laser, particularly a semiconductor laser.

Particularly advantageous for pulse measurement is an embodiment wherein the light source and light detector are disposed close to each other such that the light source will illuminate a body part of the user, preferably a part of the hand, wherewith the light detector will receive light reflected and/or dispersed by said body part. This provides a reliable [sic] means of determining the blood flow of the user, which flow varies over the pulse cycle, thereby enabling a determination of the pulse frequency.

In this connection, the light detector preferably measures the intensity of the light reflected and/or dispersed by the user—preferably as a function of time.

Preferably, the inventive scale has an evaluation unit, for determining body weight and/or body fat content and/or pulse frequency and/or blood pressure and/or water content and/or the body mass index (BMI), of the user. According to one embodiment, the evaluation unit determines the user's body fat content and/or pulse frequency and/or blood pressure from the measured current. According to another embodiment, the evaluation unit determines the user's body fat content and/or pulse frequency and/or blood pressure and/or water content and/or body mass index (BMI) from the measured voltage. According to yet another embodiment, the evaluation unit determines the user's body fat content and/or pulse frequency and/or blood pressure and/or water content and/or body mass index (BMI) from the measured light intensity. Further, the evaluation unit can determine the user's body fat content and/or pulse frequency and/or blood pressure from the timewise course of the measured voltage and/or measured current and/or measured light intensity.

E.g., for determination of the blood pressure, the evaluation unit may determine the timewise course of the electrically measured voltage signal associated with the pulse and of the optical measured signal associated with the pulse.

For determination of the blood pressure, the measurement sensor may have a blood pressure cuff (e.g. sphygmomanometer cuff). Particularly advantageous is an embodiment wherein the blood pressure cuff is adapted for measurement of the blood pressure in a finger.

According to an embodiment of the inventive scale, display means are provided, for displaying the body weight and/or body fat content and/or pulse frequency and/or blood pressure. Advantageously, such display means may attached to the hand grip. According to an advantageous embodiment, operating elements and/or input elements (e.g. a keypad) are provided within easy reach.

According to another embodiment of the inventive scale, the hand grip is provided within easy reach of a person standing on the step-on surface of the scale, preferably at hip height.

In a particularly advantageous embodiment of the inventive scale, the height (altitude) of the hand grip is adjustable.

According to another embodiment of the inventive scale, the hand grip is removable, preferably removable and reattachable, e.g. by plug means. For this purpose, a catch joint and/or a bayonet joint may be provided.

The hand grip may be in the form of a retrofit element which can be added to existing scales. In particular, the evaluation unit may be disposed in and/or on the hand grip.

Advantageously, an interface connection may be provided between the scale body and the hand grip; this connection may be, e.g., wireless, or may be an electrical plug connection.

According to an embodiment of the inventive scale, an additional interface is provided (e.g. USB, wireless LAN, infrared, or radio), for connection to a personal computer (PC).

The invention will be described (in more detail) hereinbelow with reference to schematic illustrations provided in the accompanying drawings, in which similar elements are labeled with like reference numerals.

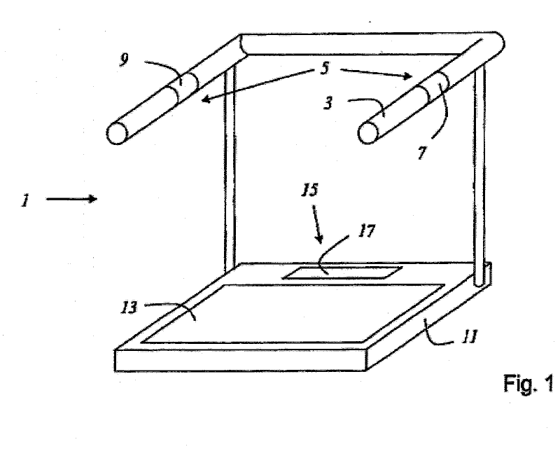

FIG. 1 illustrates an inventive scale with an electrical measurement sensor;

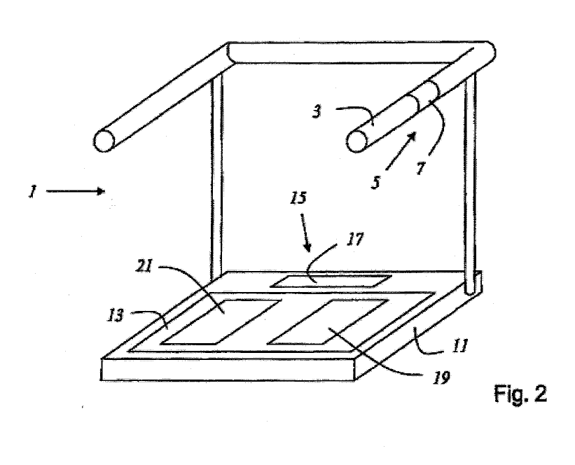

FIG. 2 illustrates an inventive scale with an electrical measurement sensor and electrical contact surfaces in the step-on plate; and

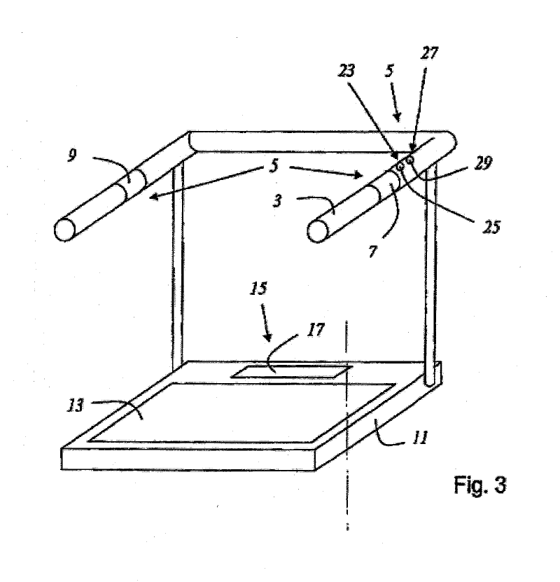

FIG. 3 illustrates an inventive scale with an electrical and optical measurement sensors and electrical contact surfaces in the step-on plate.

The inventive bathroom scale 1 (for weighing individual humans) illustrated in FIG. 1 has a hand grip 3 by which the user (the individual being weighed) can steady himself while on the scale. The hand grip 3 has an electrical measurement sensor 5, comprised of a first electrical contact surface 7 and a second electrical contact surface 9. The scale unit proper 11 has a step-on plate 13 which serves as a weighing surface (weighing table). To display the weight values and analysis values, a display means 15 is provided, here an LCD display 17. The scale also has means of detecting certain cardiac voltages (e.g. sino-atrial node voltages) as transmitted to the user's hands, namely at the electrical contact surfaces 7 and 9. (The other components of the voltage measurement means are not shown.) An evaluation unit (also not shown) for processing the measured values is disposed in the weighing unit (11).

The scale may also be used to measure the resistance of the user's body between the hands (thus between the first and second electrical contact surfaces, 7 and 9).

FIG. 2 illustrates an inventive scale 1 with a hand grip 3 by which the user can steady himself while on the scale. The hand grip 3 has an electrical measurement sensor 5, comprised of a first electrical contact surface 7. Additional contact surfaces (19, 21) are provided in the step-on plate 13.

FIG. 3 [lit., “1”] illustrates an inventive scale 1 with a hand grip 3 by which the user can steady himself while on the scale. The hand grip 3 has an electrical measurement sensor 5, comprised of a first electrical contact surface 7 and a second electrical contact surface 9. The measurement sensor 5 also has a light source 23 in the form of a light-emitting diode (LED) 25, and a light detector 27 in the form of a photodiode 29.

The light source 23 and light detector 27 are disposed close to each other such that the light source 23 can illuminate a body part of the user, preferably a part of the hand, wherewith the light detector 27 will receive light reflected and/or dispersed by said body part. This provides a reliable [sic] means of determining the blood flow of the user, which flow varies over the pulse cycle, thereby enabling a determination of the pulse frequency.

Also, advantageously in a preferred embodiment, the light detector 27 [lit., “23”] measures the intensity of light reflected and/or dispersed by the user, such measurement being preferably as a function of time, with the aid of the evaluation unit (not shown).

The scale 1 is configured and calibrated such that the evaluation unit calculates the user's blood pressure, based on the timewise behavior of the electrical voltage signal associated with the pulse and the optical signal associated with the pulse; and the blood pressure result is displayed on the display 15.

The preceding description of the invention has been with reference to particular embodiments; however it goes without saying that variants and modifications are possible without departing from the scope of protection of the claims.

1-38. (canceled)

39. A scale for weighing a user who applies his weight by stepping on the scale, comprising at least one hand grip for the user to utilize to steady himself, wherein said hand grip comprises at least one of an electrical measurement sensor or an optical measurement sensor.

40. A scale according to claim 39, wherein said electrical measurement sensor has a first electrical contact surface.

41. A scale according to claim 40, wherein said electrical measurement sensor has a second electrical contact surface.

42. A scale according to claim 41, further comprising a step-on surface, wherein said step-on surface comprises a third electrical contact surface.

43. A scale according to claim 42, wherein a test voltage may be applied between at least one of said first and second electrical contact surfaces or said first and third electrical contact surfaces.

44. A scale according to claim 43, wherein a current flows between at least one of said first and second electrical contact surfaces or said first and third electrical contact surfaces.

45. A scale according to claim 39, wherein said optical measurement sensor comprises a light detector.

46. A scale according to claim 45, wherein said light detector detects infrared light.

47. A scale according to claim 45, wherein said light detector comprises a photodiode.

48. A scale according to claim 45, wherein said optical measurement sensor further comprises a light source.

49. A scale according to claim 48, wherein said light source comprises at least one of a light emitting diode or a semiconductor laser.

50. A scale according to claim 48, wherein said light source illuminates a body part of the user, and wherein said light detector receives light reflected or dispersed by the body part.

51. A scale according to claim 50, wherein said light detector measures the intensity of light reflected or dispersed by the user.

52. A scale according to claim 51, wherein said light detector measures the intensity of light reflected or dispersed by the user, as a function of time.

53. A scale according to claim 42, further comprising a measurement element configured to measure a voltage applied between at least one of said first and second electrical contact surfaces or said first and third electrical contact surfaces.

54. A scale according to claim 53, wherein said measurement element is configured to measure a voltage applied between at least one of said first and second electrical contact surfaces or said first and third electrical contact surfaces as a function of time.

55. A scale according to claim 39, further comprising an evaluation unit for determining at least one of body weight, body fat content, pulse frequency, or blood pressure of the user.

56. A scale according to claim 55, further comprising a measurement element configured to measure at least one of voltage or current, wherein said evaluation unit determines at least one of the body fat content, pulse frequency, or blood pressure of the user from the measured current.

57. A scale according to claim 55, wherein said evaluation unit determines at least one of the body fat content, pulse frequency, or blood pressure of the user from the measured voltage.

58. A scale according to claim 55, wherein said evaluation unit determines at least one of the body fat content, pulse frequency, or blood pressure of the user from the measured light intensity.

59. A scale according to claim 55, wherein the evaluation unit determines at least one of the body fat content, pulse frequency, or blood pressure of the user r from the timewise course of: the measured current and/or measured voltage and/or measured light intensity.

60. A scale according to claim 39, wherein said electrical measurement sensor comprises a blood pressure measurement cuff.

61. A scale according to claim 60, wherein said blood pressure measurement cuff is applied to a finger of the user.

62. A scale according to claim 39, further comprising a display element that is capable of displaying at least one of the body weight, body fat content, pulse frequency, or blood pressure of the user.

63. A scale according to claim 39, further comprising a step-on surface, wherein said hand grip is disposed within the reach of the user's arm when the user is standing on said step-on surface.

64. A scale according to claim 39, wherein the height of said hand grip is adjustable.

65. A scale according to claim 39, wherein said hand grip is removable.

66. A hand grip for a scale, wherein the grip is mounted on the scale in a manner such that the user can steady himself by holding onto the grip while standing on the scale, comprising at least one of an electrical measurement sensor or an optical measurement sensor.

67. A hand grip according to claim 66, wherein said electrical measurement sensor comprises a first electrical contact surface.

68. A hand grip according to claim 67, wherein said electrical measurement sensor comprises a second electrical contact surface.

69. A hand grip according to claim 66, wherein said optical measurement sensor comprises a light detector.

70. A hand grip according to claim 69, wherein said light detector detects infrared light.

71. A hand grip according to claim 69, wherein said light detector comprises a photodiode.

72. A hand grip according to claim 69, wherein said optical measurement sensor further comprises a light source.

73. A hand grip according to claim 72, wherein said light source comprises at least one of a light emitting diode or a semiconductor laser.

74. A hand grip according to claim 66, wherein the hand grip is disposed within the reach of the user's arm when the user is standing on the scale.

75. A hand grip according to claim 66, wherein the height of the hand grip is adjustable.

76. A hand grip according to claim 66, wherein the hand grip is mountable on and removable from the scale.
